(19) United States
(12) Patent Application Publication
(10) Pub. No.: US 2025/0047169 A1
(43) Pub. Date: Feb. 6, 2025

(54) CASING FOR AN ELECTRIC MACHINE AND ASSOCIATED ELECTRIC MACHINE, COOLING CIRCUIT, VEHICLE AND COOLING METHOD

(71) Applicant: AMPERE S.A.S., Boulogne Billancourt (FR)

(72) Inventors: Bassel ASSAAD, Guyancourt (FR); Samuel GABILLARD, Cléon (FR); Frederic OUSSET, Guyancourt (FR)

(73) Assignee: AMPERE S.A.S., Boulogne Billancourt (FR)

(21) Appl. No.: 18/718,728

(22) PCT Filed: Nov. 28, 2022
(86) PCT No.: PCT/EP2022/083543

§ 371 Date: Jun. 11, 2024

(30) Foreign Application Priority Data
Dec. 13, 2021 (FR) 2113396

(51) Int. Cl. H02K 9/193; H02K 5/20

(52) U.S. Cl. CPC H02K 9/193; H02K 5/203; H02K 2209/00

(57) ABSTRACT

A casing for an electric machine includes an oil tank disposed on a lower part of the casing opposite an upper part of the casing. An oil pump is disposed between the oil tank and the lower part. The oil tank includes a funnel section oriented such that the smallest section is linked to a suction inlet of the oil pump and the largest section collects the oil running down in the casing.

The present invention relates to the cooling of electric machines.

The present invention relates more particularly to a casing for an electric machine, an electric machine equipped with such a casing, a cooling circuit and a cooling method for such a machine, and an electric motor vehicle equipped with such an electric machine.

Generally, an electric motor vehicle comprises an electric motor and a motor cooling circuit in which a coolant circulates.

The circuit comprises a coolant storage container or tank, for example of oil, and a pump for circulating the fluid in the circuit.

The container is generally disposed at the bottom of the casing such that the oil is stored under the electric motor.

The oil is generally viscous at low temperature (−20° C.).

The pump is generally added on to the casing above the container and comprises a duct linked to a strainer.

The pump is dimensioned to suck the viscous oil from the bottom of the casing and discharge the oil above the motor.

In order to suck in and discharge the viscous oil, the pump develops a significant suction power leading to a significant energy consumption for its power supply.

Furthermore, the bulk of such a pump and the bulk of the tank are generally significant.

It is therefore proposed to mitigate all or part of the above-mentioned drawbacks.

In light of the above, the subject of the invention is a casing for an electric machine, comprising an oil tank disposed on a lower part of the casing opposite an upper part of the casing.

An oil pump is disposed between the oil tank and the lower part, the oil tank comprising a funnel section oriented such that the smallest section is linked to a suction inlet of the oil pump and the largest section is configured to collect the oil running down in the casing.

Also a subject of the invention is an electric machine comprising a casing as defined previously and a rotor, the rotor being disposed in the casing such that the oil contained in the oil tank is sprayed in the casing by the rotating rotor.

Preferably, the electric machine further comprises a stator housing the rotor and comprising stator coils, the stator being disposed in the casing such that when the rotor is stopped, the oil contained in the oil tank at least partially covers a part of the stator coils.

Also a subject of the invention is a cooling circuit comprising an electric machine as defined previously, and at least one orifice linked to an oil supply duct and disposed in the upper part of the stator situated in the upper part of the casing, the supply duct being linked to a discharge outlet of the oil pump such that the oil discharged by the oil pump flows over the rotor.

Advantageously, the casing comprises two bearings holding the rotor in the casing, each bearing comprising a lubrication orifice disposed in the upper part of the casing and linked to the supply duct.

Preferably, the cooling circuit further comprises a heat exchanger comprising a primary circuit linking the discharge outlet of the oil pump to the supply duct, and comprising a secondary circuit intended to be linked to a second cooling circuit.

Also a subject of the invention is an electric motor vehicle comprising a cooling circuit as defined previously, and a second cooling circuit, the second cooling circuit comprising a cooling radiator, a cooling pump, a valve and at least one electrical component, the outlet of the radiator being linked to a first inlet of the valve, an outlet of the valve being linked to a suction inlet of the cooling pump, a discharge outlet of the cooling pump being linked to a cooling inlet of the component, a cooling outlet of the component being linked to an inlet of the secondary circuit of the heat exchanger, an outlet of the secondary circuit of the heat exchanger being linked to an inlet of the radiator and to a second inlet of the valve, the valve being configured such that, as long as the temperature of a fluid circulated by the cooling pump in the second cooling circuit is lower than a setpoint temperature, the fluid flows through the second inlet and the outlet of the valve such that the fluid does not flow through the radiator, and such that, as soon as the temperature of the fluid is greater than or equal to the setpoint temperature, the fluid flows through the radiator, the first inlet of the valve and the outlet of the valve.

Preferably, the valve comprises a thermostatic valve.

Also a subject of the invention is a method for cooling an electric machine as defined previously, the oil tank being filled with oil, comprising:
the rotation of the rotor such that the rotor sprays the oil contained in the oil tank inside the casing, and
the activation of the oil pump as soon as the temperature of the oil is greater than or equal to a control temperature such that the oil flows over the rotor.

Preferably, if the oil of the oil tank at least partially covers a part of the stator coils when the rotor is stopped, the method comprises, prior to the rotation of the rotor, the powering of the stator coils to heat up the oil contained in the oil tank.

Other aims, features and advantages of the invention will become apparent on reading the following description, given purely as a nonlimiting example, and given with reference to the attached drawings in which:

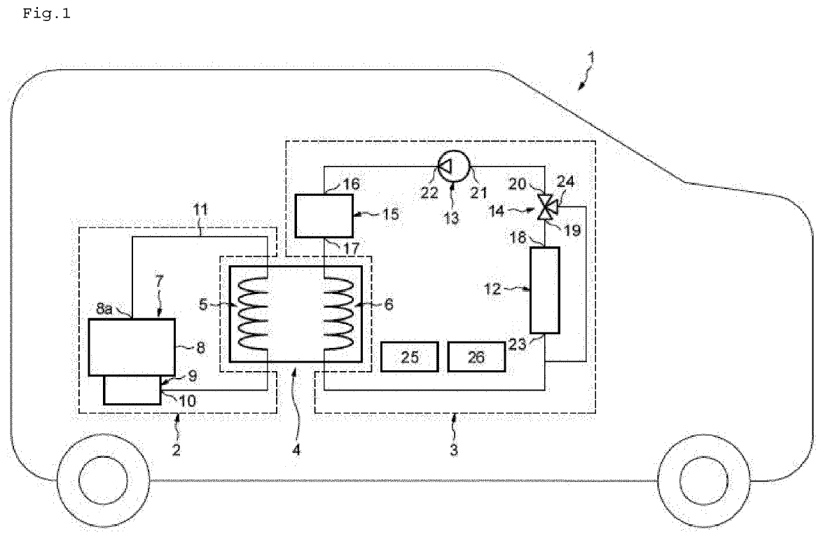

FIG. 1 schematically illustrates an electric motor vehicle according to the invention;

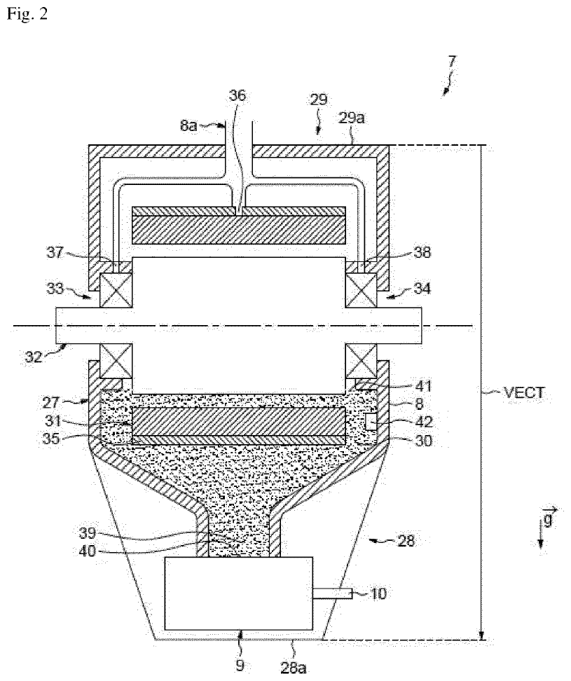

FIG. 2 schematically illustrates an exemplary embodiment of an electric machine according to the invention;

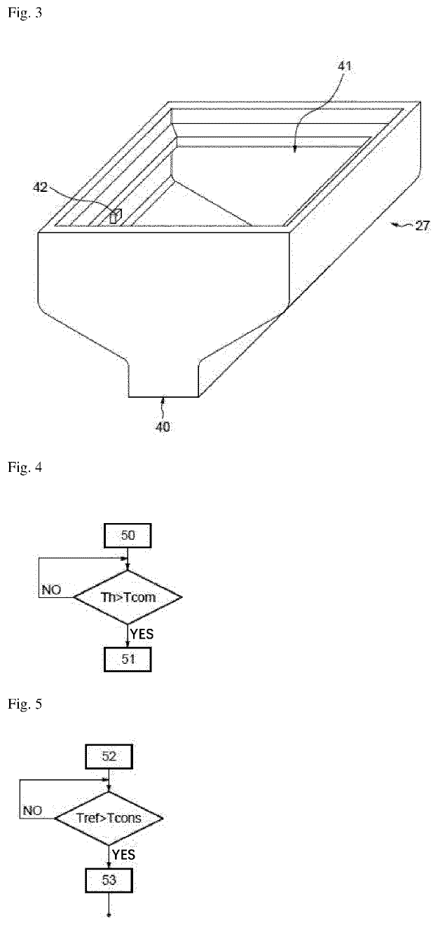

FIG. 3 schematically illustrates an exemplary embodiment of an oil tank according to the invention;

FIG. 4 schematically illustrates an example of a method for cooling the electric machine according to the invention; and

FIG. 5 schematically illustrates an example of a start-up step of the electric motor vehicle according to the invention.

FIG. 1 illustrates a motor vehicle 1 comprising a first cooling circuit 2 and a second cooling circuit 3 linked by a heat exchanger 4 comprising a primary circuit 5 and a secondary circuit 6.

The first cooling circuit 2 comprises an electric machine 7 comprising a casing 8 and an oil pump 9.

A discharge outlet 10 of the pump 9 is linked by a supply duct 11 and via the primary circuit 5 of the exchanger 4 to an inlet 8a of the casing 8.

Oil set in motion by the pump 9 circulates in the first circuit 2 to cool the machine 7.

The second cooling circuit 3 comprises a cooling radiator 12, a cooling pump 13, a valve 14, and at least one electrical component 15 comprising a cooling inlet 16 and a cooling outlet 17.

The electrical component 15 comprises, for example, a power electrical component that needs to be cooled, for example a power converter driving the machine 7, a battery supplying power to said power converter.

As a variant, several components needing to be cooled are incorporated in the second circuit 2.

According to yet another variant, the power component 15 is replaced by another cooling circuit comprising, for example, power electrical components that need to be cooled for example via a heat exchanger or linked directly to the second cooling circuit 3.

An outlet of the radiator 18 is linked to a first inlet 19 of the valve 14.

An outlet 20 of the valve 14 is linked to a suction inlet 21 of the cooling pump 13.

A discharge outlet 22 of the cooling pump 13 is linked to the cooling inlet 16 of the component 15, and the cooling outlet 17 of the component 15 is linked to an inlet of the secondary circuit 6 of the heat exchanger 4.

An outlet of the secondary circuit of the heat exchanger 4 is linked to an inlet 23 of the radiator 12 and to a second inlet 24 of the valve 14.

The second circuit 3 can further comprise means 25 for measuring the temperature of the fluid.

The measurement means 25 comprise for example a temperature sensor.

The second circuit 3 cools the component 15 from the coolant circulated by the cooling pump 13 in said circuit.

The coolant comprises, for example, glycol water.

The valve 14 comprises, for example, a valve of three-way type.

As long as the temperature Tref measured by the measurement means 25 is lower than a setpoint temperature Tcons, the valve 14 is driven such that the fluid flows through the second inlet 24 of the valve 14 and through the outlet 20 of the valve 14. The fluid does not flow through the radiator 12.

As soon as the temperature of the fluid is greater than or equal to the setpoint temperature Tcons, the valve 14 is driven such that the fluid flows through the radiator 12, the first inlet 19 of the valve 14 and the outlet 20 of the valve 14.

The valve 14 is for example driven by control means 26 based on the temperature Tref recorded by the measurement means 25.

The control means 26 comprise, for example, a processing unit.

According to another embodiment, the valve 14 comprises a thermostatic valve, the second circuit 3 not comprising the measurement means 25 and the control means 26.

FIG. 2 schematically illustrates an exemplary embodiment of the electric machine 7.

The casing 8 comprises an oil tank 27 disposed on a lower part 28 of the casing 8 opposite an upper part 29 of the casing 8.

The oil tank 27 stores oil 30 when the machine 7 is stopped.

A surface 29a of the upper part 29 is linked to a surface 28a of the lower part 28 by a vector VECT parallel to the gravitational vector \vec{g}.

The machine 7 comprises a stator 31, a rotor 32 housed in the stator 31, and two bearings 33, 34 comprising, for example, ball bearings holding the rotor in the casing 8.

The machine 7 further comprises sealing means (not represented) for preventing the oil 30 from escaping from the casing 8.

A yoke 35 of the stator 31 comprises at least one orifice 36 disposed in the upper part of the stator 31 situated in the upper part 29 of the casing 8 and linked to the inlet 8a of the casing 8 such that the oil 30 discharged by the oil pump 9 flows over the rotor 32.

The orifice 36 sprays oil over the rotor 32 and the stator 31 in order to cool the rotor and the stator.

Under the effect of gravity, the oil reheated by its passage over the rotor and the stator runs down into the oil tank 27.

The bearings 33, 34 each comprise a lubrication orifice 37, 38 linked to the inlet 8a of the casing 8.

The oil 30 discharged by the oil pump 9 flows into the bearings 33, 34 through the orifices 37, 38 to lubricate and cool said bearings.

As a variant, the bearings 37, 38 are of the self-lubricating type, the casing 8 not comprising the orifices 37, 38.

The oil pump 9 is disposed between the oil tank 27 and the lower part 28.

The oil tank 27 comprises a funnel section oriented such that the smallest section 39 is linked to a suction inlet 40 of the oil pump 9, and the largest section 41 collects the oil 30 running down in the casing 8.

The oil 30 contained in the casing 8 is driven in the lower part 28 of the casing 8 by gravity making it possible to reduce the suction capacity of the pump 9.

The reduction of the capacity of the pump 9 makes it possible to reduce the bulk of the pump 9 and the consumption of the pump 9.

Furthermore, since the pump 9 is disposed under the oil tank 27, the pump 9 does not become unprimed when the oil level is inclined in the oil tank following the inclination of the vehicle 1.

The incorporation of the pump 9 in the casing 8 further makes it possible to reduce the number of elements compared to an added-on oil pump as known from the state-of-the-art.

The rotor 32 is disposed in the casing 8 such that the oil 30 contained in the oil tank 27 is sprayed in the casing 8 by the rotating rotor 32.

The oil tank 27 is further dimensioned such that when the pump 9 discharges oil 30, the oil level in the tank 27 is sufficient to prevent the unpriming of the pump 9 in order to reduce the quantity of oil in the casing 8 (dry casing).

The dimensioning of the tank 27 is done for example on the basis of a digital simulation model of the tank 27 or on the basis of a prototype.

The tank 27 further comprises a temperature sensor 42 measuring the temperature Th of the oil 30 in the tank 27.

FIG. 3 illustrates an exemplary embodiment of the tank 27.

FIG. 4 illustrates an example of a method for cooling the electric machine 7.

It is assumed that the tank 27 is filled with oil 30.

During a step 50, the rotor 32 is rotated under the effect of a magnetic field generated by the stator coils 31.

The rotor 32 sprays the oil 30 in the casing 8 by splashing.

The oil 30 is heated up by the splashing.

During a step 51, when the temperature Th of the oil measured by the sensor 42 is greater than or equal to a control temperature Tcom, control means (not represented) actuate the pump 9.

The heating up of the oil by the splashing of the rotor 32 makes it possible to trigger the pump 9 when the oil has reached the control temperature, the control temperature being equal to the lower bound of the range of optimal operating temperatures of the pump in order to minimize the fluid frictions of the oil 30 in the pump 9 to reduce the energy consumption of the pump 9.

As a variant, before the rotor 31 is rotated during a conditioning step, if the oil 30 contained in the oil tank 27 at least partially covers a part of the stator coils 31, the method comprises, prior to the rotation of the rotor 31, the powering of the stator coils 31 to heat up the oil 30 contained in the oil tank 27 such that the oil 30 more rapidly reaches the control temperature Tcom.

According to yet another variant, before the rotation of the rotor 31 during a start-up step of the vehicle 1, the energy released by the electrical component 15 is transmitted to the oil 30 via the heat exchanger 4 when the pump 9 is operating.

FIG. 5 illustrates an example of the start-up step of the vehicle 1.

During a substep 52, the cooling pump 13 transfers the coolant reheated by the electrical component 15 into the secondary circuit 6 of the heat exchanger 4 such that the energy contained in the fluid reheats the oil of the first circuit 2 flowing in the primary circuit 5 under the effect of the oil pump 9.

In order to transfer all of the energy dissipated in the coolant, as long as the temperature Tref measured by the means 25 is lower than the setpoint temperature Tcons, the valve 14 is driven such that the fluid flows through the second inlet 24 of the valve 14 and through the outlet 20 of the valve 14. The fluid does not flow through the radiator 12 preventing the energy contained in the coolant from being dissipated outside of the vehicle 1, and such that the energy dissipated in the coolant reheats the oil via the exchanger 4.

As soon as the temperature of the fluid is greater than or equal to the setpoint temperature Tcons, the valve 14 is driven such that the fluid flows through the radiator 12, the first inlet 19 of the valve 14 and the outlet 20 of the valve 14 (substep 53).

The start-up step makes it possible to more rapidly reheat the oil 30 from the energy dissipated by the electrical component 15, to reduce the fluid frictions in the pump 9 and thus reduce the consumption of said pump.

Obviously, the cooling method can comprise both the conditioning step and the start-up step.

1.-10. (canceled)

11. A casing for an electric machine, comprising:
an oil tank disposed on a lower part of the casing opposite an upper part of the casing; and,
an oil pump disposed between the oil tank and the lower part, the oil tank comprising a funnel section oriented such that a smallest section is linked to a suction inlet of the oil pump and a largest section is configured to collect oil running down in the casing.

12. An electric machine comprising:
the casing as claimed in claim 11; and
a rotor disposed in the casing such that the oil contained in the oil tank is sprayed in the casing by the rotating rotor.

13. The electric machine as claimed in claim 12, further comprising a stator housing the rotor and comprising stator coils, the stator being disposed in the casing such that when the rotor is stopped, the oil contained in the oil tank at least partially covers a part of the stator coils.

14. A cooling circuit comprising:
the electric machine as claimed in claim 12; and
at least one orifice linked to an oil supply duct and disposed in the upper part of the stator situated in the upper part of the casing, the supply duct being linked to a discharge outlet of the oil pump such that the oil discharged by the oil pump flows over the rotor.

15. The cooling circuit as claimed in claim 14, wherein the casing comprises two bearings holding the rotor in the casing, each bearing comprising a lubrication orifice disposed in the upper part of the casing and linked to the supply duct.

16. The cooling circuit as claimed in claim 14, further comprising a heat exchanger comprising a primary circuit linking the discharge outlet of the oil pump to the supply duct, and comprising a secondary circuit configured to be linked to a second cooling circuit.

17. An electric motor vehicle comprising:
the cooling circuit as claimed in claim 16; and
a second cooling circuit, the second cooling circuit comprising a cooling radiator, a cooling pump, a valve and at least one electrical component, an outlet of the radiator being linked to a first inlet of the valve, an outlet of the valve being linked to a suction inlet of the cooling pump, a discharge outlet of the cooling pump being linked to a cooling inlet of the component, a cooling outlet of the component being linked to an inlet of the secondary circuit of the heat exchanger, an outlet of the secondary circuit of the heat exchanger being linked to an inlet of the radiator and to a second inlet of the valve, the valve being configured such that as long as the temperature of a fluid circulated by the cooling pump in the second cooling circuit is lower than a setpoint temperature, the fluid flows through the second inlet and the outlet of the valve such that the fluid does not flow through the radiator, and such that as soon as the temperature of the fluid is greater than or equal to the setpoint temperature, the fluid flows through the radiator, the first inlet of the valve and the outlet of the valve.

18. The vehicle as claimed in claim 17, wherein the valve comprises a thermostatic valve.

19. A method for cooling the electric machine as claimed in claim 12, the oil tank being filled with oil, the method comprising:
rotating the rotor such that the rotor sprays the oil contained in the oil tank inside the casing; and
activating the oil pump as soon as the temperature of the oil is greater than or equal to a control temperature such that the oil flows over the rotor.

20. A method for cooling the electric machine as claimed in claim 13, the oil tank being filled with oil, the method comprising:
rotating the rotor such that the rotor sprays the oil contained in the oil tank inside the casing; and
activating the oil pump as soon as the temperature of the oil is greater than or equal to a control temperature such that the oil flows over the rotor.

21. The method as claimed in claim 20, wherein when the oil of the oil tank at least partially covers a part of the stator coils when the rotor is stopped, the method comprises, prior to the rotating the rotor, powering of the stator coils to heat up the oil contained in the oil tank.
